(19) United States
(12) Patent Application Publication
(10) Pub. No.: US 2025/0371315 A1
(43) Pub. Date: Dec. 4, 2025

(54) CONSTRAINED STRUCTURED DATA GENERATION

(71) Applicant: INTERNATIONAL BUSINESS MACHINES CORPORATION, Armonk, NY (US)

(72) Inventors: Sameer Anil Pimparkhede, Akola (IN); Prince Kumar, Mohiuddin Nagar (IN); Srikanth Govindaraj Tamilselvam, Chennai (IN); Ashok Pon Kumar Sree Prakash, Bangalore (IN); Mehant Kammakomati, Hyderabad (IN); Padmanabha Venkatagiri Seshadri, Mysore (IN)

(21) Appl. No.: 18/731,832

(22) Filed: Jun. 3, 2024

(51) Int. Cl. G06N 3/0455

(52) U.S. Cl. CPC G06N 3/0455

(57) ABSTRACT

Methods and systems for deploying a system include generating a term in a configuration file using a prompt to a language model, constrained by an initial template that identifies fixed and variable parts according to a schema. The template is dynamically updated in accordance with an output of the language model. A next term in the configuration file is generated based on the prompt, constrained by the updated template. Next terms are generated and the template is iteratively updated until a halt condition has been reached to complete the configuration file.

### BACKGROUND

The present invention generally relates to generative machine learning systems and, more particularly, to the constrained generation of structured data.

A domain-specific language may be used to configure software in a distributed computing system. For example, ANSIBLE® is an infrastructure orchestration automation tool that uses a playbook to declare infrastructure features. In this manner, the tool helps to manage devices in an inventory of devices that may be dynamically selected for a task. The playbook may be stored as a text file that is written in any appropriate format, such as YAML.

Writing a playbook for a given deployment is a time-consuming process, particularly in instances where portions of the playbook are repetitive from one deployment to another and instances where modules are employed that an engineer may be unfamiliar with. The deployment of a computer system, for example creating virtual machines by deploying and configuring software, can involve complex manual creation of configuration instructions. For example, a playbook may be written in YAML to provide instructions that define and configure software packages that will be deployed when a virtual machine is deployed.

### SUMMARY

A method for deploying a system includes generating a term in a configuration file using a prompt to a language model, constrained by an initial template that identifies fixed and variable parts according to a schema. The template is dynamically updated in accordance with an output of the language model. A next term in the configuration file is generated based on the prompt, constrained by the updated template. Next terms are generated and the template is iteratively updated until a halt condition has been reached to complete the configuration file.

A deployment system includes a hardware processor and a memory. The memory stores a computer program that, when executed by the hardware processor, causes the hardware processor to generate a term in a configuration file using a prompt to a language model, constrained by an initial template that identifies fixed and variable parts according to a schema, to dynamically update the template in accordance with an output of the language model, to generate a next term in the configuration file based on the prompt, constrained by the updated template, and to iteratively generate next terms and updating the template until a halt condition has been reached to complete the configuration file.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram of a distributed computing system that uses a playbook for software configuration, in accordance with an embodiment of the present invention;

FIG. 2 is a block diagram of a processing node in a distributed computing system that uses a playbook for software configuration, in accordance with an embodiment of the present invention;

FIG. 3 is a diagram showing a prompt to a language model for automatically generating a playbook for software configuration, in accordance with an embodiment of the present invention;

FIG. 4 is a diagram showing unconstrained output from a language model generating a playbook for software configuration, in accordance with an embodiment of the present invention;

FIG. 5 is a diagram showing constrained output from a language model, based on a template, generating a playbook for software configuration, in accordance with an embodiment of the present invention;

FIG. 6 is a block/flow diagram of a method for automatically generating a playbook for software configuration using a language model, in accordance with an embodiment of the present invention;

FIG. 7 is a block/flow diagram of a method for dynamically updating a template for automatically generating a playbook, in accordance with an embodiment of the present invention;

FIG. 8 is a block/flow diagram for automatically generating a playbook for software configuration, in accordance with an embodiment of the present invention;

FIG. 9 is a block diagram of a computer that can perform automated playbook generation, in accordance with an embodiment of the present invention;

FIG. 10 is a diagram of an exemplary neural network architecture that can be used as part of a model to automatically generate a playbook for software configuration, in accordance with an embodiment of the present invention; and

FIG. 11 is a diagram of an exemplary deep neural network architecture that can be used as part of a model to automatically generate a playbook for software configuration, in accordance with an embodiment of the present invention.

### DETAILED DESCRIPTION

Structured configuration instructions can be automatically generated using a large language model (LLM) using natural language instructions. However, a pretrained LLM may not have access to external knowledge sources, for example defining a schema for the configuration instructions. Extending the LLM to cover such outputs would need examples to predict valid sets of <key, value> pairs for the task, which may not be available. Additionally, some out-of-context tokens may not be applicable for a given module. However, schema are available for most modules, with descriptions and documentation for the fields in the schema.

An LLM may be used to fill the blanks of a schema while keeping the rest of the output deterministic to ensure adherence to the schema. The schema may specify mandatory key, type, possible value patterns, conditions, and so on. This information may be used to specify deterministic outputs, while the LLM is used to generate the unknown values. An initial template may be updated during end-to-end generation, as generation flow and following <key, value> pairs can depend on the previously generated <key, value> pairs.

In some cases an LLM may generate non-compliant outputs that include, for example, extra whitespace, indentation, or out-of-order blocks. In such cases, parts of the output may be deleted and generated again.

Thus a schema may be specified as a template with specific areas to be filled with <key, value> pairs by an LLM. Particular patterns and values may be specified in the template for known <key,value> pairs. The template may further be dynamically altered based on the generation flow, for example changing the template in response to particular tokens being generated by the LLM. Token healing may be performed based on schema conditions to re-generate <key, value> pairs. External knowledge sources may be specified and leveraged based on conditions. An example of such a condition may be the version number of a software module that is to be used during generation, which can determine which knowledge sources should be targeted for that particular version.

According to an aspect of the invention, there is provided a method for deploying a system includes generating a term in a configuration file using a prompt to a language model, constrained by an initial template that identifies fixed and variable parts according to a schema. The template is dynamically updated in accordance with an output of the language model. A next term in the configuration file is generated based on the prompt, constrained by the updated template. Next terms are generated and the template is iteratively updated until a halt condition has been reached to complete the configuration file. Dynamically updating the template makes it possible to guide the creation of a configuration file using predetermined information about the schema for the configuration file and a particular software module.

In embodiments, dynamically updating the template is performed responsive to a last term by adding a predetermined new template to the initial template. The use of a template to constrain the output of the language model makes it easy to add new constraints during the generation of the configuration file.

In embodiments, the schema is derived from documentation for a software module being configured by the configuration file. Deriving the scheme based on documentation for the software module makes it possible to determine a template that is tailored to the particular needs of the software module.

In embodiments, the schema includes a set of required keys and wherein the template expresses the required keys in a syntax that is interpreted by a grammar parser. The use of required keys is an example of how the output of the language model may be constrained to ensure the configuration file correctly configures the software module.

In embodiments, dynamically updating the template identifies that a previous term is a key for a nested schema and adds a nested template to the template. The detection of nested schemas makes represents one type of adaptation the dynamic template may make to the output of the language model, where particular keys have their own rules for what keys and values may be needed.

In embodiments, the initial template includes a constraint selected from the group consisting of generation from a given set of options, generation of a value that follows a particular pattern, data format constraints, and grammar rules. The templates can be used to impose a variety of constraints on the output of the language model.

In embodiments, the configuration file may be executed to configure a software module in a distributed computing system, wherein the prompt specifies the software module. The configuration file has a practical application in automatically configuring the software module within the computing system, and can itself be automatically generated.

In embodiments, the initial template and a template update for dynamically updating the template are specified prior to generating the term. The predetermination of the initial template and any template updates makes it possible to automatically generate configuration files that comply with constraints dictated by the schema for the software module.

In embodiments, specifying the template update includes determining conditions from the schema that are triggered by particular terms. The identification of these terms in the output of the language model makes it possible to adapt the template for generating the configuration file responsive to what the language model actually produces.

In embodiments, the language model is a large language model that is pretrained on code generation samples. Such language models can rapidly generate code, but their output may not comply with the actual needs of a given software module. The present dynamic template updates make it possible to use pretrained language models while still ensuring compliance.

According to an aspect of the invention, there is a computer program product for deploying a system. The computer program product has a computer readable storage medium having program instructions embodied therewith, the program instructions executable by a hardware processor to cause the hardware processor to generate a term in a configuration file using a prompt to a language model, constrained by an initial template that identifies fixed and variable parts according to a schema, to dynamically update the template in accordance with an output of the language model, to generate a next term in the configuration file based on the prompt, constrained by the updated template, and to iteratively generate next terms and updating the template until a halt condition has been reached to complete the configuration file. Dynamically updating the template makes it possible to guide the creation of a configuration file using predetermined information about the schema for the configuration file and a particular software module.

According to an aspect of the invention, a deployment system includes a hardware processor and a memory. The memory stores a computer program that, when executed by the hardware processor, causes the hardware processor to generate a term in a configuration file using a prompt to a language model, constrained by an initial template that identifies fixed and variable parts according to a schema, to dynamically update the template in accordance with an output of the language model, to generate a next term in the configuration file based on the prompt, constrained by the updated template, and to iteratively generate next terms and updating the template until a halt condition has been reached to complete the configuration file. Dynamically updating the template makes it possible to guide the creation of a configuration file using predetermined information about the schema for the configuration file and a particular software module.

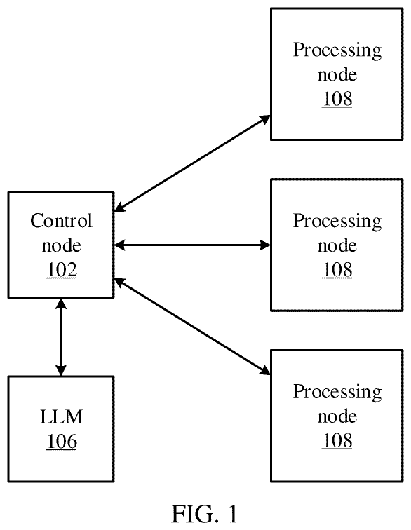

Referring now to FIG. 1, a distributed computing system is shown. A control node 102 interacts with a number of processing nodes 108, each of which represents a separate logical or physical processing system. An LLM 106 is used to generate a configuration file to configure deployment on one or more processing nodes 108 that are managed by the control node 102.

In some embodiments, a domain-specific language may be used on the control node 102 to manage a container orchestration system, such as Kubernetes. For example, such a domain-specific language may include an ANSIBLE® playbook or an OPENSHIFT® YAML file, with ANSIBLE® playbooks being described herein as a particular example of the configuration file. In such embodiments, the playbook may make use of a Kubernetes module to implement container orchestration, including deployment and configuration of containers on the processing nodes 108. The control node 102 may make use of a variety of ANSIBLE® modules, each of which may represent program code that may run on one or more processing nodes 108. The playbook may be a text file on the control node 102 that indicates how the modules, plugins, and roles may be used, and may be defined in a YAML format.

The LLM may be any appropriate model, for example a pre-trained transformer-based model that is trained on a corpus of information including code generation samples. The LLM 106 may be hosted on the same hardware as the control node 102 or may be hosted on a remote system, for example one that is controlled by a different entity. The control node 102 may issue natural language prompts to the LLM 106, or such prompts may be input by a user, and the results from the LLM 106 may be used to generate configuration information based on a playbook schema.

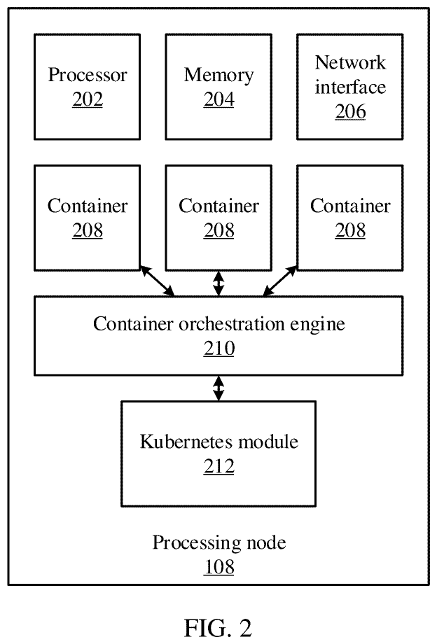

Referring now to FIG. 2, additional detail on a processing node 108 is shown. The processing node 108 includes a hardware processor 202, a memory 204, and a network interface 206. The network interface 206 is configured to communicate with the control node 102 and with other processing nodes 108 as needed, using any appropriate wired or wireless communications medium and protocol. The processing node 108 also includes one or more functional modules that may, in some embodiments, be implemented as software that is stored in the memory 204 and that is executed by the hardware processor 202. In other embodiments, one or more of the functional modules may be implemented as one or more discrete hardware components in the form of, e.g., application-specific integrated chips or field programmable gate arrays.

The processing node 108 includes one or more containers 208. It is specifically contemplated that each container 208 represents a distinct operating environment. The containers 208 each include a set of software applications, configuration files, workload datasets, and any other information or software needed to execute a specific workload. The containers 208 are stored in memory 204 and are instantiated and decommissioned by the container orchestration engine 210 as needed. It should be understood that, as a general matter, an operating system of the processing node 108 exists outside the containers 208. Thus, each container 208 interfaces with the same operating system kernel, reducing the overhead needed to execute multiple containers simultaneously. The containers 208 meanwhile generally have no communication with one another outside of specifically agreed-to interfaces, reducing security concerns.

The container orchestration engine 210 may be implemented or managed by a Kubernetes module 212, which in turn may have been deployed and configured by the control node 102. In addition to the Kubernetes module 212, a number of other modules may be deployed by the control node 102 in accordance with a playbook.

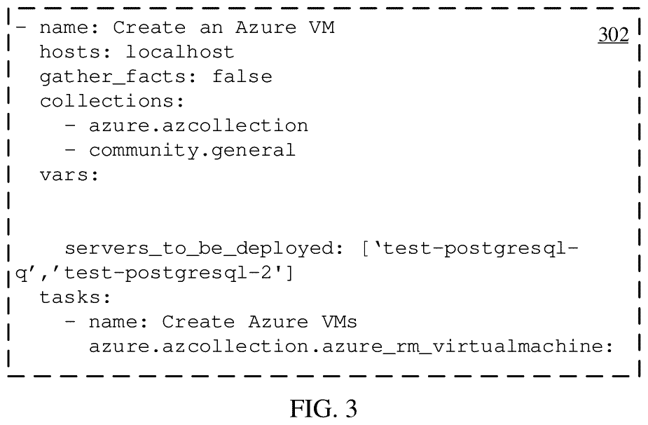

Referring now to FIG. 3, an exemplary input 302 to the LLM 106 is shown. The input 302 includes a context portion, a query portion, and a module name. Providing the input 302 as a prompt to the LLM 106 generates a YAML file output that represents a playbook for deployment on a processing node 108. In this example, everything from the first line to “tasks:” may be regarded as the context portion, with the remainder being the query. The module name in this example is “azure.azcollection.azure_rm_virtualmmachine”.

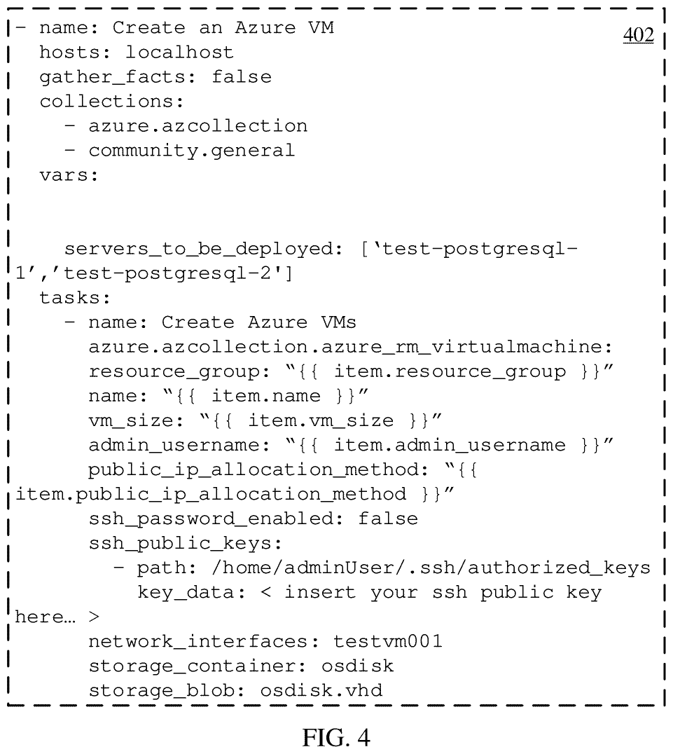

Referring now to FIG. 4, an exemplary unconstrained output 402 from the LLM 106 is shown. In this output, the LLM has failed to generate an “image” key and the subsequent code under that parent key, despite being a required field.

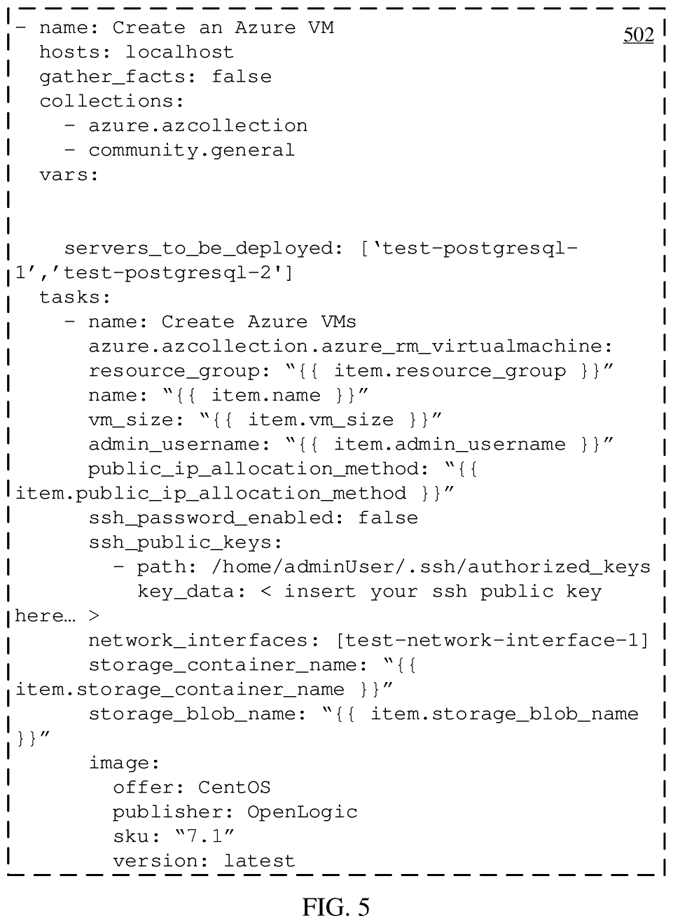

Referring now to FIG. 5, an exemplary constrained output 502 from the LLM 106 is shown. The constrained output 502 includes elements that are missing from the unconstrained output 402, as the inclusion of these elements may be enforced by a schema. In some cases the key name has been changed (e.g., from “network_interfaces” to “network_interface_names”) to more accurately reflect the schema.

For example, keys may be selected from the schema “azure.azcollection.azure_rm_virtualmachine”. This module calls for three keys: image, resource_group, and name, with other keys being optional. The LLM 106 may be provided with a template to constrain its output. An example of a template's syntax may be:

$$\{ \{ \#geneach “ items ” min\_iteration = 0 max\_iteration = 6 \} \} \{ \{ \#select key \} \} image \{ \{ or \} \} resource\_group \{ \{ or \} \} name \{ \{ or \} \} ssh\_public \_keys \{ \{ or \} \} network\_interfaces \{ \{ or \} \} vm\_size \{ \{ / select \} \} \{ \{ gen value options = options\_available \} \} \{ \{ / geneach \} \}$$

This template specifies six total keys, including required keys and optional keys. Required keys may be distinguished from optional keys based on the documentation for the software module in question. The template can be structured to identify which keys are required and which are optional. The “select” is used to generate the keys from the provided options. The “gen” is used, after generating the key, to generate a value for that key in an unconstrained manner, using the entire token vocabulary. Value generation may be controlled by custom stopping criteria for the LLM 106, which specify that LLM generation should be stopped if the model produces less than, or equal to, the amount of indentation generated in the previous line. The complete block is executed between zero and six times, so the number of iterations is left as a decision for the LLM 106 to make.

A user may know the structure of the schema in advance, and may want to change the template during operation if the model generates a specific output. For example, if the generated value has ten trailing spaces, this suggests that nested keys have to be produced, and so a different set of options may be needed. A new template may be used with different options:

$$options\_available = \{ .*\ n\ s {10}$”:{{#geneach items min_iterations=0 max_iterations=4}} {{#selected key }} offer {{ or }}sku {{ or }} version { { or }} location {{ / select }} {{gen value \text{"\}\} \{\{} / geneach \text{\}\}}$$

The template may have multiple constraints, such as generation from a given set of options or generating a value that follows a particular pattern. Templates may be generated by subject matter experts or other users of the system. The new template may be in dictionary format, including <key, value> pairs enclosed in { } braces. For example, such a template may specify {key1: value1, key2: value2, . . . }. The new template may be input to the LLM as a constraint for the generation of subsequent tokens. Other examples of constraints that may be used include data format constraints for values in the language being used. Grammar rules may be defined for the language as well to further constrain the output of the LLM.

Once the template is given as an input to the LLM 106, it is parsed using a grammar parser and is stored in a tree format. The tree maintains the state about the part of the template to be generated and the one which is not to be generated. The LLM 106 is provided all the level-1 keys in the schema as options (e.g., resource_group, name, vm_size, etc). The model generates values from the options specified in the template. Once a key is generated, the schema is checked for nested keys. If there are required nested keys, the LLM 106 is compelled to generate values for those, while the generation of optional nested keys is left up to the model. In one example, the key “ssh_public_keys” may have nested keys such as “path”, “key_data”, and “location”. Here “path” is a compulsory key, while the others may be optional. The information is fetched from the schema and a new template may be formed as:

$$new\_template = generated string till that point + “ path ” + \{ \{ gen “ value ” \} \} + \{ \{ \# geneach “ items ” min\_iterations = 0 max\_iterations = 2 \} \} \{ \{ \#select key \} \} location \{ \{ or \} \} key\_data \{ \{ / select \} \} \{ \{ gen “ value ” \} \} \{ \{ / geneach \} \} + Original template for level 1 keys$$

The tree format of the template may be a hierarchical data structure that includes nodes, with blocks in the template being executed in a hierarchical manner. For the above example, gen_each is a loop under which the select block executes. A level 1 key is a top-level key, which are directly accessible without further nesting. Beyond level 1 keys, there are subsequent levels of keys that are nested within each other. These subsequent levels may be referred to as deeper levels or nested levels. A nested key may be identified as a key that comes after a new-line character and white space tokens.

Once a value is generated by the LLM 106, a regular expression for a dynamic template may be matched and the template may be changed by appending a user-input template to the generated text up to that point. For example, once two spaces or more of indentation is generated for a module name, the template to select from level-1 keys may be appended dynamically to the existing value.

When the LLM 106 finishes generating level-1 keys and starts producing a next task, generation can be stopped. Following the example above of the unconstrained output 402, the LLM 106 may start work on the next task after a “storage_blob” <key, value> pair. The schema is used to identify required keys that have been missed by the LLM 106. In this example, the “image” key is missing. Required keys may then be included in the template dynamically and the LLM 106 may be used to generate the missing information to produce the constrained output 502. For example, the template for the “image” key may be added and the LLM 106 may be rerun to generate appropriate values. Such a template may be formed by appending “‘image’+ {{gen “value”}}” to the string generated up to that point. Once all required keys have been generated, generation is halted. This halt condition may be detected when the LLM 106 produces indentation that is less than the module name line. Following the example above, this may be when a line is generated that is indented less than “azure.azcollection.azure_rm_virtualmachine”.

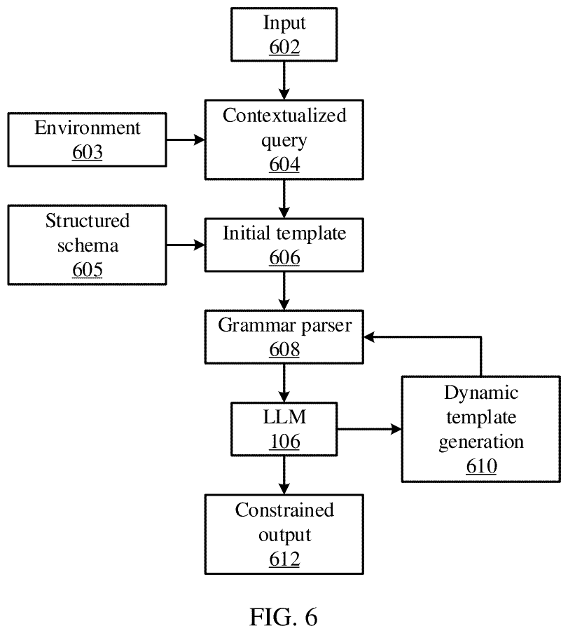

Referring now to FIG. 6, a method for constrained, structured data generation is shown. An input 602 is converted into a contextualized query 604 using information from the environment 603. The systems application programming interface (API) may be used to collect information for the environment.

The contextualized query 604 is used to create an initial template 606 based on structured schema information 605 relating to the query. The structured schema 605 may identify fixed parts of the expected output and variable parts, for example identifying required and optional keys and identifying areas where the LLM 106 will generate corresponding values.

A grammar parser 608 converts the initial template 606 into a tree format, which may include different options for dynamic changes to the template. The template is used to constrain the output of the LLM 106 to generate an initial output that may not fully comply with requirements 7 of the schema. Dynamic template generation 610 may then adapt the template based on the initial output, providing a predetermined updated template that is appended to the initial output. The updated template is parsed by the grammar parser 608 and is provided to the LLM 106 to affect its output. This process may repeat until a fully complaint constrained output 612 is generated by the LLM 106.

The template is applied to the output of the LLM 106, for example by modifying the probabilities of logits generated by the LLM 106 before they are decoded into text. The template is translated by the grammar parser 608 into instructions on how such probabilities may be altered. For example, if the template specifies that one of a set of words is to be used, then probabilities for other words may be reduced to zero. Dynamically updating the template 610 can be performed on a token-by-token basis as the LLM 106 generates outputs, so that each subsequent token may be constrained by an updated template that is based on the previously generated tokens.

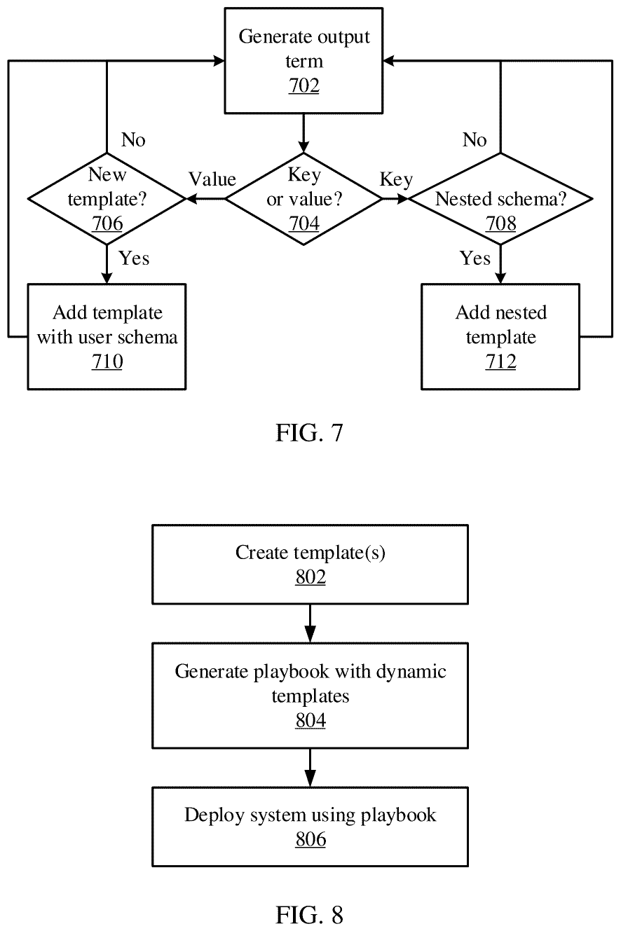

Referring now to FIG. 7, a method for data generation with dynamic templates is shown. Block 702 generates an output term according to a present template. For example, this may be the initial template for level-1 keys, which is parsed by the grammar parser 608 and which is provided as an input to LLM 106. The LLM 106 outputs a key or value in response to the prompt, and block 704 determines which.

If the output is a value, block 706 determines whether the user has specified a new template that is to be used for that value. If so, block 710 adds the new template with a user-input schema to the output and block 702 generates the next term using the new template. If not, then the next term is generated using the old template.

If the output is a key, block 708 determines whether the key has a nested schema. If so, block 712 adds a nested template to the output and block 702 generates the next term using the nested template. If not, then the next term is generated using the old template. The nested schema refers to a hierarchical structure, where data is organized into levels of indentation. Each level represents a deeper level of nesting within the hierarchy, with each nested level having its own set of key-value pairs.

Referring now to FIG. 8, a method for creating a playbook for system deployment is shown. Block 802 creates one or more templates that reflect a schema for software that is to be deployed at the system. Block 804 uses LLM 106 to generate a playbook with dynamic templates as described above, adapting the template being used based on the model's outputs. The result is a constrained output that can be used as a playbook for deploying a system in block 806. Deployment may include the instantiation of a virtual machine, the installation of software on an existing system, and/or the transfer of an image or container to a processing node.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

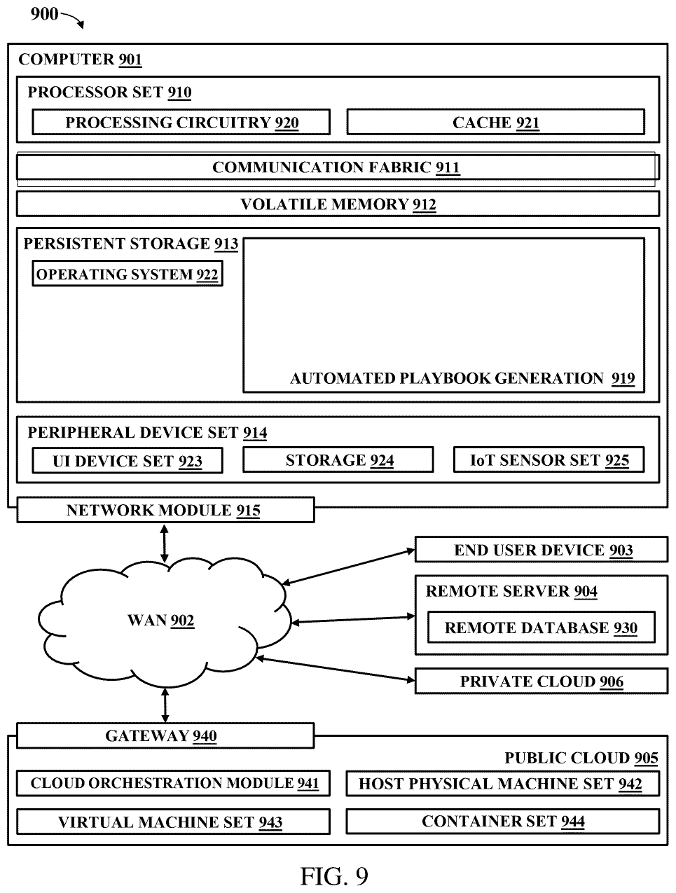

Referring now to FIG. 9, a block diagram of a computing environment is shown. Computing environment 900 contains an example of an environment for the execution of at least some of the computer code involved in performing the inventive methods, such as automated playbook generation 919. In addition to block 919, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 919, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible.

Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 919 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in block 919 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices.

Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

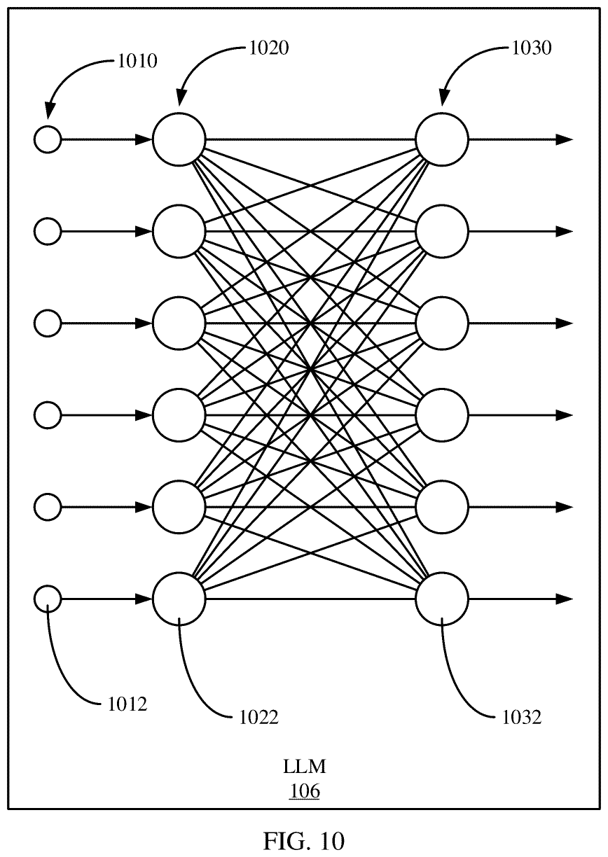

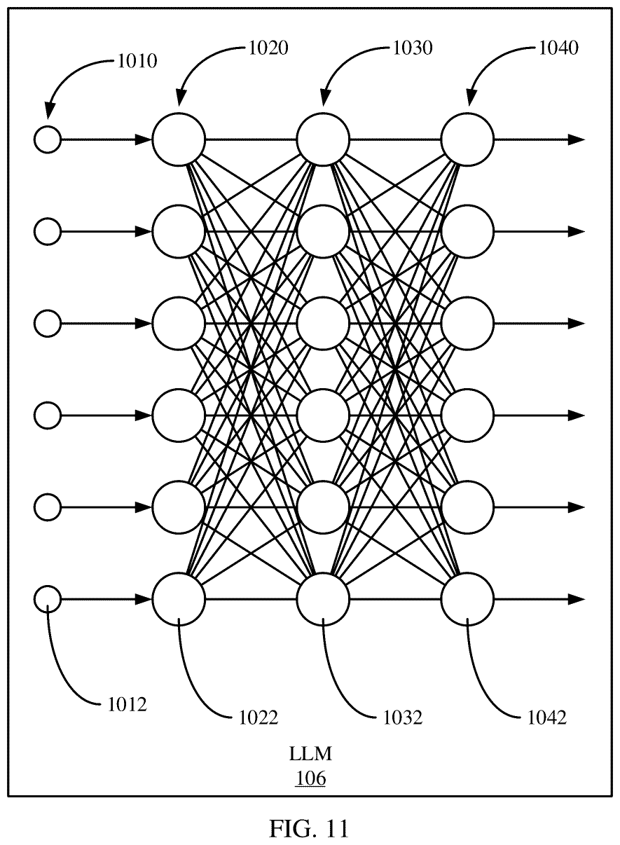

Referring now to FIGS. 10 and 11, exemplary neural network architectures are shown, which may be used to implement parts of the present models, such as the LLM 106. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 1020 of source nodes 1022, and a single computation layer 1030 having one or more computation nodes 1032 that also act as output nodes, where there is a single computation node 1032 for each possible category into which the input example could be classified. An input layer 1020 can have a number of source nodes 1022 equal to the number of data values 1012 in the input data 1010. The data values 1012 in the input data 1010 can be represented as a column vector. Each computation node 1032 in the computation layer 1030 generates a linear combination of weighted values from the input data 1010 fed into input nodes 1020, and applies a non-linear activation function that is differentiable to the sum. The exemplary simple neural network can perform classification on linearly separable examples (e.g., patterns).

A deep neural network, such as a multilayer perceptron, can have an input layer 1020 of source nodes 1022, one or more computation layer(s) 1030 having one or more computation nodes 1032, and an output layer 1040, where there is a single output node 1042 for each possible category into which the input example could be classified. An input layer 1020 can have a number of source nodes 1022 equal to the number of data values 1012 in the input data 1010. The computation nodes 1032 in the computation layer(s) 1030 can also be referred to as hidden layers, because they are between the source nodes 1022 and output node(s) 1042 and are not directly observed. Each node 1032, 1042 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of constrained structured data generation (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for deploying a system, comprising:
generating a term in a configuration file using a prompt to a language model, constrained by an initial template that identifies fixed and variable parts according to a schema;
dynamically updating the template in accordance with an output of the language model;
generating a next term in the configuration file based on the prompt, constrained by the updated template; and
iteratively generating next terms and updating the template until a halt condition has been reached to complete the configuration file.

2. The method of claim 1, wherein dynamically updating the template is performed responsive to a last term by adding a predetermined new template to the initial template.

3. The method of claim 1, wherein the schema is derived from documentation for a software module being configured by the configuration file.

4. The method of claim 1, wherein the schema includes a set of required keys and wherein the template expresses the required keys in a syntax that is interpreted by a grammar parser.

5. The method of claim 1, wherein dynamically updating the template identifies that a previous term is a key for a nested schema and adds a nested template to the template.

6. The method of claim 1, wherein the initial template includes a constraint selected from the group consisting of generation from a given set of options, generation of a value that follows a particular pattern, data format constraints, and grammar rules.

7. The method of claim 1, further comprising executing the configuration file to configure a software module in a distributed computing system, wherein the prompt specifies the software module.

8. The method of claim 1, further comprising specifying the initial template and a template update for dynamically updating the template prior to generating the term.

9. The method of claim 8, wherein specifying the template update includes determining conditions from the schema that are triggered by particular terms.

10. The method of claim 1, wherein the language model is a large language model that is pretrained on code generation samples.

11. A computer program product for deploying a system, the computer program product comprising a computer readable storage medium having program instructions embodied therewith, the program instructions executable by a hardware processor to cause the hardware processor to:
generate a term in a configuration file using a prompt to a language model, constrained by an initial template that identifies fixed and variable parts according to a schema;
dynamically update the template in accordance with an output of the language model;
generate a next term in the configuration file based on the prompt, constrained by the updated template; and
iteratively generate next terms and updating the template until a halt condition has been reached to complete the configuration file.

12. A deployment system, comprising:
a hardware processor; and
a memory that stores a computer program which, when executed by the hardware processor, causes the hardware processor to:
generate a term in a configuration file using a prompt to a language model, constrained by an initial template that identifies fixed and variable parts according to a schema;
dynamically update the template in accordance with an output of the language model;
generate a next term in the configuration file based on the prompt, constrained by the updated template; and
iteratively generate next terms and updating the template until a halt condition has been reached to complete the configuration file.

13. The deployment system of claim 12, wherein the dynamic update of the template is performed responsive to a last term by adding a predetermined new template to the initial template.

14. The deployment system of claim 12, wherein the schema is derived from documentation for a software module being configured by the configuration file.

15. The deployment system of claim 12, wherein the schema includes a set of required keys and wherein the template expresses the required keys in a syntax that is interpreted by a grammar parser.

16. The deployment system of claim 12, wherein the dynamic update of the template identifies that a previous term is a key for a nested schema and adds a nested template to the template.

17. The deployment system of claim 12, wherein the initial template includes a constraint selected from the group consisting of generation from a given set of options, generation of a value that follows a particular pattern, data format constraints, and grammar rules.

18. The deployment system of claim 12, wherein the computer program further causes the hardware processor to execute the configuration file to configure a software module in a distributed computing system, wherein the prompt specifies the software module.

19. The deployment system of claim 12, wherein the computer program further causes the hardware processor to specify the initial template and a template update for dynamically updating the template prior to generation of the term.

20. The deployment system of claim 19, wherein the specification of the template update includes a determination of conditions from the schema that are triggered by particular terms.
